(19) United States
(12) Patent Application Publication
(10) Pub. No.: US 2022/0284110 A1
(43) Pub. Date: Sep. 8, 2022

(54) MULTI-KEY SECURE DEDUPLICATION USING LOCKED FINGERPRINTS

(71) Applicant: International Business Machines Corporation, Armonk, NY (US)

(72) Inventors: Steven Robert Hetzler, Los Altos, CA (US); John Stewart Best, San Jose, CA (US); Wayne C. Hineman, San Jose, CA (US)

(21) Appl. No.: 17/191,430

(22) Filed: Mar. 3, 2021

(51) Int. Cl. G06F 21/60; G06F 3/06; H04L 9/32; H04L 9/14

(52) U.S. Cl. CPC G06F 21/602; G06F 3/0623; G06F 3/0641; G06F 3/0689; H04L 9/3242; H04L 9/14

(57) ABSTRACT

A computer-implemented method includes computing a fingerprint of a data chunk, encrypting the fingerprint with a fingerprint key, and encrypting the data chunk with a base key and the encrypted fingerprint. The method also includes encrypting the encrypted fingerprint with a user key to generate a doubly encrypted fingerprint and sending the encrypted data chunk and the doubly encrypted fingerprint to a storage system. The storage system does not have access to the base key, the fingerprint key and the user key. A computer-implemented method includes computing a fingerprint of a data chunk and encrypting the data chunk with a base key and the fingerprint. The method also includes encrypting the fingerprint with a user key and sending the encrypted data chunk and the encrypted fingerprint to a storage system. The storage system does not have access to the base key and the user key.

### BACKGROUND

The present invention relates to secure deduplication, and more particularly, this invention relates to multi-key secure deduplication using locked fingerprints in cloud storage systems and networks.

Conventional data reduction techniques, such as deduplication and/or compression, do not provide meaningful reduction when applied to encrypted data. Deduplication of multiple sets of data, each encrypted with a unique encryption key, breaks down where the various encryption algorithms prevent conventional deduplication processes from identifying duplicate data chunks. Conventional data reduction techniques also do not provide adequate data privacy between the client and the storage system.

For example, one known bring your own key (BYOK) encryption technique involves a multi-party trust system. Although all data reduction functions may be provided by the storage system which has access to all the data, conventional BYOK systems provide no data privacy between the storage system and the client because the storage system has access to the client key. The third party key service also has access to the shared encryption key used to encrypt the client data. Data privacy only exists between the users for this form of BYOK encryption.

Conventional at-rest encryption encrypts unencrypted input data with key(s) known to the storage system. The storage system may decrypt all the data and perform deduplication against all the data in the system. However, at-rest encryption provides no data privacy.

Conventional full client-side encryption encrypts the data with a key unknown to the storage system. The storage system only deduplicates data encrypted with a common key. Full client-side deduplication provides relatively high data privacy but impedes deduplication efficiency.

### BRIEF SUMMARY

A computer-implemented method, according to one approach, includes computing a fingerprint of a data chunk, encrypting the fingerprint with a fingerprint key, and encrypting the data chunk with a base key and the encrypted fingerprint. The method also includes encrypting the encrypted fingerprint with a user key to generate a doubly encrypted fingerprint and sending the encrypted data chunk and the doubly encrypted fingerprint to a storage system. The storage system does not have access to the base key, the fingerprint key and the user key. The foregoing method provides users having different user keys with the benefit of deduplication across the set of keys while providing data privacy between users.

The computer-implemented method optionally includes that the storage system is configured to perform deduplication operations on the encrypted data chunk. This optional approach enables secure deduplication of encrypted data using fingerprints which are encrypted with unique user keys.

A system, according to another approach, includes a processor and logic integrated with the processor, executable by the processor, or integrated with and executable by the processor. The logic is configured to perform the foregoing method.

A computer program product, according to another approach, includes one or more computer readable storage media, and program instructions collectively stored on the one or more computer readable storage media, the program instructions include program instructions to perform the foregoing method.

A computer-implemented method, according to one approach, includes computing a fingerprint of a data chunk and encrypting the data chunk with a base key and the fingerprint. The method also includes encrypting the fingerprint with a user key and sending the encrypted data chunk and the encrypted fingerprint to a storage system. The storage system does not have access to the base key and the user key. The foregoing method provides the ability to securely deduplicate encrypted data with enhanced protection from attacks.

The computer-implemented method optionally includes encrypting the data chunk with the base key and the fingerprint uses XTS mode AES encryption. This optional approach provides protection against an attacker moving an encrypted chunk from one location to another location and implicitly encrypts the initialization vector as part of encrypting the data chunk.

A computer program product, according to another approach, includes one or more computer readable storage media, and program instructions collectively stored on the one or more computer readable storage media, the program instructions include program instructions to perform the foregoing method.

Other aspects and approaches of the present invention will become apparent from the following detailed description, which, when taken in conjunction with the drawings, illustrate by way of example the principles of the invention.

### BRIEF DESCRIPTION OF THE DRAWINGS

FIG. 1 depicts a cloud computing environment in accordance with one aspect of the present invention.

FIG. 2 depicts abstraction model layers in accordance with one aspect of the present invention.

FIG. 3 is a diagram of a high level architecture, in accordance with one aspect of the present invention.

FIG. 4 is a diagram of a high level architecture, in accordance with one aspect of the present invention.

FIG. 5 is a flowchart of a method, in accordance with one aspect of the present invention.

FIG. 6 is a flowchart of a method, in accordance with one aspect of the present invention.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several aspects of multi-key secure deduplication using locked fingerprints.

In one general aspect, a computer-implemented method includes computing a fingerprint of a data chunk, encrypting the fingerprint with a fingerprint key, and encrypting the data chunk with a base key and the encrypted fingerprint. The method also includes encrypting the encrypted fingerprint with a user key to generate a doubly encrypted fingerprint and sending the encrypted data chunk and the doubly encrypted fingerprint to a storage system. The storage system does not have access to the base key, the fingerprint key and the user key.

In another general aspect, a system includes a processor and logic integrated with the processor, executable by the processor, or integrated with and executable by the processor. The logic is configured to perform the foregoing method.

In another general aspect, a computer program product includes one or more computer readable storage media, and program instructions collectively stored on the one or more computer readable storage media, the program instructions include program instructions to perform the foregoing method.

In yet another general aspect, a computer-implemented method includes computing a fingerprint of a data chunk and encrypting the data chunk with a base key and the fingerprint. The method also includes encrypting the fingerprint with a user key and sending the encrypted data chunk and the encrypted fingerprint to a storage system. The storage system does not have access to the base key and the user key.

In another general aspect, a computer program product includes one or more computer readable storage media, and program instructions collectively stored on the one or more computer readable storage media, the program instructions include program instructions to perform the foregoing method.

It is to be understood that although this disclosure includes a detailed description on cloud computing, implementation of the teachings recited herein are not limited to a cloud computing environment. Rather, aspects of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

### Characteristics are as Follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

### Service Models are as Follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

### Deployment Models are as Follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

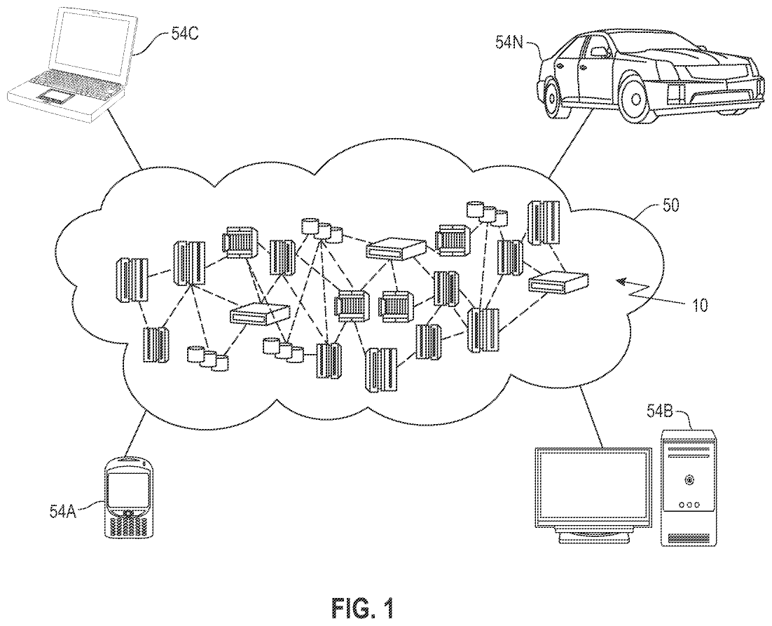

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

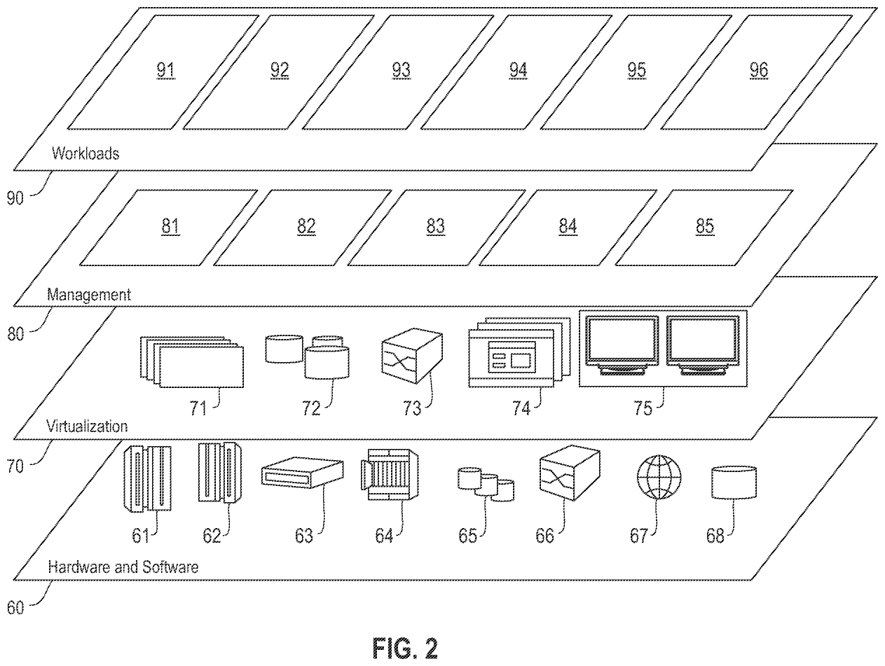

Referring now to FIG. 2, a set of functional abstraction layers provided by cloud computing environment 50 (FIG. 1) is shown. It should be understood in advance that the components, layers, and functions shown in FIG. 2 are intended to be illustrative only and aspects of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some aspects, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and multi-key secure deduplication using locked fingerprints 96.

Conventional data reduction techniques, such as deduplication and/or compression, do not provide meaningful reduction when applied to encrypted data. Deduplication of multiple sets of data, each encrypted with a unique encryption key, breaks down where the various encryption algorithms prevent conventional deduplication processes from identifying duplicate data chunks. Conventional data reduction techniques also do not provide adequate data privacy between the client and the storage system.

The keep your own key (KYOK) approach for secure deduplication achieves deduplication of encrypted data without having access to any other client's encryption key. Data from a client key may be deduped against other data in that key. Various aspects of the present disclosure provide users having different user keys with the benefit of deduplication across the set of keys while providing data privacy between users. The present disclosure enables secure deduplication of encrypted data using fingerprints which are encrypted with unique user keys, without the storage system having access to shared keys or the user keys, and without sharing the user keys between users.

At least some aspects of the present disclosure provide additional abilities to KYOK secure deduplication which allow for a client to use multiple keys to encrypt data. The various aspects improve upon the deduplication of KYOK by increasing the set of data which the deduplication is capable of operating on. The various approaches described herein maintain data privacy and improve data privacy compared to conventional encryption and/or deduplication techniques. Various operations for multi-key encryption data deduplication using locked fingerprints provide relatively better data reduction than conventional full client-side encryption and less client overhead than client-side deduplication.

Various aspects of the present disclosure enable data deduplication on encrypted data, without the deduplication layer having access to the encryption keys. Security for data is enhanced when data is encrypted at the host, and the data encryption key is not shared with the storage. In conventional systems, once data is encrypted, the ability to deduplicate and/or compress the data is significantly reduced. In stark contrast, at least some aspects of the present disclosure enable data deduplication on encrypted data utilizing locked fingerprints created with different keys to provide cryptographic isolation. An advantage provided by various aspects described herein is substantially no information is leaked on deduplication to data owners while providing improved data privacy and data integrity.

Deduplication of encrypted data has been problematic for the storage industry for at least the reasons described herein. Conventional approaches for deduplicating encrypted data include convergent, or deterministic, encryption where identical plaintext data is encrypted so as to provide identical ciphertext. Moreover, conventional convergent encryption does not provide the ability to deduplicate data encrypted using different keys because identical plaintext encrypted in different keys will not produce identical ciphertext. In conventional deduplication processes, if a host system sends encrypted data to a storage system, deduplication with identical plaintext data that was encrypted in a different key will fail (e.g., no deduplication occurs), because these conventional processes do not create identical ciphertext for identical plaintext inputs. Conventional convergent encryption is a form of encryption which does create identical ciphertext for identical plaintext inputs but does not allow for different keys that provide cryptographic isolation between users. The present disclosure allows for deduplication of encrypted data having this convergent property, while requiring different keys for decryption.

At least some of the operations described herein may be used with symmetric key encryption and/or asymmetric key encryption (e.g., public key infrastructure (PKI)). It should be understood by one having ordinary skill in the art that PKI encryption may be performed according to any configuration known in the art. For example, a public key in PKI is not a secret key, and encrypting data with the public key requires a corresponding secret private key to decrypt.

Clients throughout various aspects of the present disclosure are associated with a set of processes, users, other entities, etc., which have separate data access privileges. A host system may have any number of users which write/read data to a storage system via the host system as would be understood by one having ordinary skill in the art. In various aspects, it is assumed that all communications between disjoint components occur over mutually authenticated secure (e.g., encrypted) sessions.

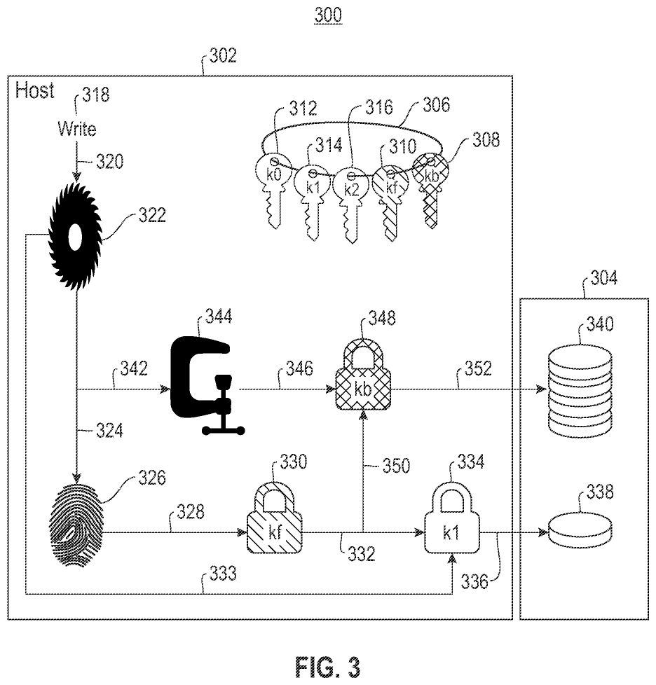

FIG. 3 is a diagram of a high-level architecture, in accordance with various configurations. The architecture 300 may be implemented in accordance with the present invention in any of the environments depicted in FIGS. 1-2 and 4-6, among others, in various configurations. Of course, more or less elements than those specifically described in FIG. 3 may be included in architecture 300, as would be understood by one of skill in the art upon reading the present descriptions.

Architecture 300 illustrates an exemplary approach for secure deduplication of encrypted data using fingerprints which are encrypted with unique user keys. Architecture 300 illustrates an exemplary write operation for the secure deduplication. Architecture 300 includes a host system 302 and a storage system 304. The storage system 304 may be any type of storage system known in the art. It should be understood by one having ordinary skill in the art that the storage system 304 may have more or less components than those listed herein. The storage system 304 preferably performs various deduplication operations described herein.

In various aspects, the storage system 304 is configured to perform data deduplication using any data deduplication techniques known in the art. The storage system 304 preferably performs deduplication on input data chunks by computing fingerprints on the data and checking if the fingerprint for a data chunk matches the fingerprint of another data chunk, to be described in further detail below. In response to determining that the fingerprints for the data chunks match, the data chunks may be deduplicated (e.g., only one copy of the data chunk is stored and any other data chunk(s) with matching fingerprint(s) points to the stored data chunk, in a manner known in the art).

The host system 302 comprises a key group 306 (e.g., a set of keys). The key group 306 includes a base key kb 308, a fingerprint key kf 310, and user keys k0 312, k1 314, and k2 316. Deduplication is permitted between data written by the holders of user keys k0 312, k1 314, and k2 316 which belong to the key group 306. Deduplication is not permitted between data written in keys not belonging to the key group 306. In various aspects, the fingerprint key and the base key are shared between the users in the key group. The user keys are not shared between users in the key group. In various aspects, deduplication is not permitted against data written as plaintext.

For write operation 318, the write data 320 is passed to the chunker 322. The chunker 322 splits the write data 320 into data chunks. In preferred aspects, the chunker 322 splits the write data 320 into fixed length data chunks. In other aspects, the chunker 322 splits the write data 320 into variable sized length data chunks, in a manner known in the art, in view of the intended application and/or design. An output data chunk is passed in operation 324 to fingerprint generator 326 and then, in operation 328, sent to the first fingerprint encrypter/decrypter 330. The fingerprint generator 326 generates a fingerprint of the data chunk in a manner known in the art. In preferred aspects, the fingerprint generator 326 computes a fingerprint using any cryptographic hash algorithm in the art including a MD5, SHA-1, SHA-256, etc. The first fingerprint encrypter/decrypter 330 encrypts and/or decrypts the fingerprint using the fingerprint key kf 310, in a manner known in the art. In preferred aspects, the first fingerprint encrypter/decrypter 330 encrypts and/or decrypts the fingerprint using the fingerprint key kf 310 to generate an encrypted fingerprint.

In various aspects, the fingerprint is computed using a keyed-hash message authentication code (HMAC). An HMAC is defined in RFC 2104 and is a function of a key, a message and a cryptographic hash. An HMAC effectively computes a fingerprint of the message encrypted by a key. As shown in FIG. 3, an HMAC may combine the fingerprint generated by the fingerprint generator 326 and the encryption element (e.g., the encrypted fingerprint) encrypted by the first fingerprint encrypter/decrypter 330. The HMAC message will be the data chunk plaintext (e.g., as in the data chunk is passed in operation 324) and the key is the fingerprint key kf 310.

The encrypted fingerprint is sent in operation 332 to a second fingerprint encrypter/decrypter 334 for further encryption in a user key. The user key is preferably a key which is not shared with other users in the key group. As shown, the user (e.g., performing the write operation) is associated with user key k1 314 and the second fingerprint encrypter/decrypter 334 encrypts the encrypted fingerprint with the user key k1 314, in a manner known in the art, to generate a doubly encrypted fingerprint. In various aspects, a doubly encrypted fingerprint may be interchangeably referred to as a “locked fingerprint.”

In at least some approaches, for fixed block storage, the logical block address for the plaintext block (e.g., of the write data 320) is used as the initialization vector (IV) (e.g., or a “tweak” for tweakable cipher modes) for the user key encryption of the encrypted fingerprint. The logical block address may be sent in operation 333 to the second fingerprint encrypter/decrypter 334 to be used as the initialization vector, as shown in FIG. 3. In at least some aspects, AES-XTS type encryption may be used. AES-XTS encryption provides protection against an attacker moving an encrypted chunk from one location to another location.

As shown in FIG. 3, the doubly encrypted fingerprint (e.g., the locked fingerprint, which is the fingerprint of the data chunk encrypted with the fingerprint key and then encrypted with the user key) is sent in operation 336 to the metadata storage 338. In one approach, the metadata storage 338 is stored separately from the data storage 340, as shown in FIG. 3, in a separate storage device. In another approach, the metadata storage 338 may be combined with data storage 340.

In some approaches, the data chunk of write data 320 is sent in operation 342 to a compression unit 344. The compression unit 344 compresses the data in a manner known in the art to produce identical compressed output for identical input. The compressed data chunk is sent in operation 346 to the data encrypter/decrypter 348. The data encrypter/decrypter 348 may be of an AES-XTS type. In an alternative approach, the data encryption performed by the data encrypter/decrypter 348 may be the nested type where input data chunk of the write data 320 is encrypted first using the base key kb 308 or using the encrypted fingerprint (which is output by the first fingerprint encrypter/decrypter 330 and sent to the data encrypter/decrypter 348 in operation 350) as the fingerprint key and then further encrypting the data chunk using the other of the base key kb 308 or the encrypted fingerprint as the encryption key. In one approach, the base key kb 308 is used as the encryption key and the encrypted fingerprint sent in operation 350 is used as the IV, in a manner known in the art. The output ciphertext data chunk is sent in operation 352 to the data storage 340.

As described above, in preferred aspects, the data encrypter/decrypter 348 operates in a manner that both base key kb 308 and the encrypted fingerprint are required to decrypt the data chunk and recover the plaintext data chunk. The data encrypter/decrypter 348 has the property that input data chunks produce identical encrypted data chunks (e.g., which are output and sent to the data storage 340 in operation 352, as described herein). This property allows the storage system 304 to identify data for the purposes of deduplication (e.g., the storage system 304 is able to identify encrypted data chunks which “match” for deduplication, in a manner known in the art, even though the storage system 304 does not see the plaintext data (e.g., the data in the clear)).

The result of writing an input data is that the storage system 304 stores both the encrypted data chunk and the associated doubly encrypted fingerprint (e.g., encrypted using the fingerprint key kf 310 at the first fingerprint encrypter/decrypter 330 and then further encrypted using the user key k1 314 at the second fingerprint encrypter/decrypter 334). The storage system 304 may store the encrypted data chunk and the associated doubly encrypted fingerprint in a manner so as to maintain this relationship. For example, encrypted fingerprints (e.g., doubly encrypted fingerprints) may be stored in the metadata storage 338 that associates doubly encrypted fingerprints with encrypted data chunks.

In other approaches, the storage system comprises the encrypted data chunk and the doubly encrypted fingerprint where “doubly encrypted” refers to a fingerprint which is encrypted using the fingerprint key kf 310 at the first fingerprint encrypter/decrypter 330, and then encrypted by the AES-XTS type encryption described herein at the second fingerprint encrypter/decrypter 334. In one approach, the storage system 304 is a block store and the metadata may include the logical block address of the data chunk as the association information, in a manner which would become apparent to one having ordinary skill in the art upon reading the present disclosure.

In some approaches, the storage system applies at-rest encryption to the data and/or the metadata, without affecting the operation of the multi-key secure deduplication, in a manner which would become apparent to one having ordinary skill in the art upon reading the present disclosure. At-rest encryption beneficially provides an additional level of security for the data and/or the metadata. For example, an attacker obtaining physical data access (e.g., such as through theft of a storage device from the storage system) would need to possess the client encryption key, the client shared keys, the client not-shared keys, and the storage encryption key to bypass the additional at-rest encryption, as would be understood by one having ordinary skill in the art.

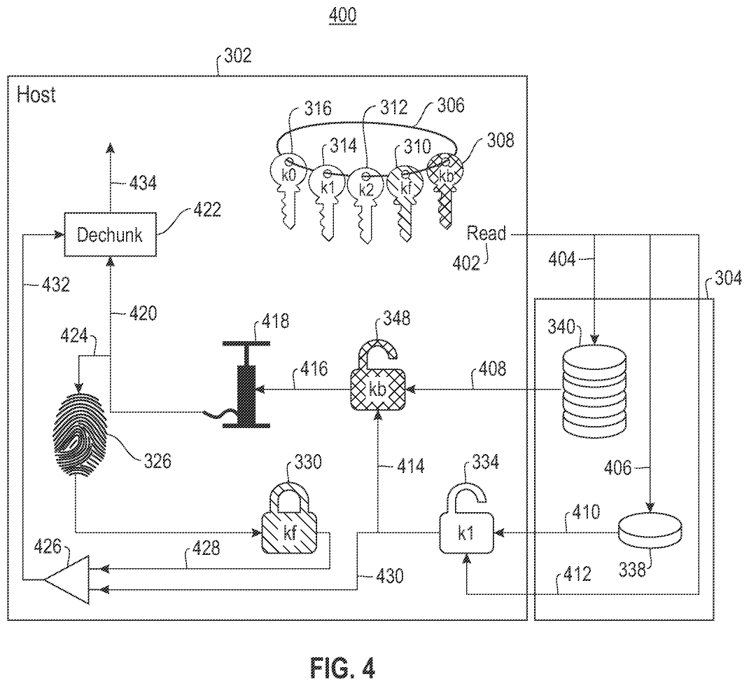

FIG. 4 is a diagram of a high-level architecture, in accordance with various configurations. The architecture 400 may be implemented in accordance with the present invention in any of the environments depicted in FIGS. 1-3 and 5-6, among others, in various configurations. Of course, more or less elements than those specifically described in FIG. 4 may be included in architecture 400, as would be understood by one of skill in the art upon reading the present descriptions.

Architecture 400 illustrates an exemplary approach for secure deduplication of encrypted data using fingerprints which are encrypted with unique user keys. Architecture 400 illustrates an exemplary read operation for the secure deduplication. Architecture 400 includes a host system 302 and a storage system 304. The storage system 304 may be any type of storage system known in the art. It should be understood by one having ordinary skill in the art that the storage system 304 may have more or less components than those listed herein. The storage system 304 preferably performs various deduplication operations described herein.

In various aspects, the storage system 304 is configured to perform data deduplication using any data deduplication techniques known in the art. The storage system 304 preferably performs deduplication on input data chunks by computing fingerprints on the data and checking if the fingerprint for a data chunk matches the fingerprint of another data chunk, to be described in further detail below. In response to determining that the fingerprints for the data chunks match, the data chunks may be deduplicated (e.g., only one copy of the data chunk is stored and any other data chunk(s) with matching fingerprint(s) points to the stored data chunk, in a manner known in the art).

The host system 302 comprises a key group 306 (e.g., a set of keys). The key group 306 includes a base key kb 308, a fingerprint key kf 310, and user keys k0 312, k1 314, and k2 316. Deduplication is permitted between data written by the holders of user keys k0 312, k1 314, and k2 316 which belong to the key group 306. Deduplication is not permitted between data written in keys not belonging to the key group 306. In various aspects, the fingerprint key and the base key are shared between the users in the key group. The user keys are not shared between users in the key group. In various aspects, deduplication is not permitted against data written as plaintext.

At operation 402, a read request is issued for data. In the case of fixed block storage, the read is the data at a set of logical block addresses. At operation 404, the read request is passed to the data storage 340 to read the data (e.g., the encrypted data chunks associated with the read request) and, at operation 406, the read request is passed to the metadata storage 338 to read the associated metadata (e.g., the doubly encrypted fingerprints associated with the data chunks associated with the read request). At operation 408, an encrypted data chunk is sent to the data encrypter/decrypter 348 which decrypts the encrypted data chunk using the base key kb 308 and the IV used for the encryption/decryption, in manner which would be understood by one having ordinary skill in the art upon reading the present disclosure.

At operation 410, the associated metadata (e.g., the doubly encrypted fingerprint associated with the encrypted data chunk) is sent to the second fingerprint encrypter/decrypter 334 which decrypts the doubly encrypted fingerprint using the user key k1 314 in manner which would be understood by one having ordinary skill in the art upon reading the present disclosure to produce an encrypted fingerprint (e.g., a singly encrypted fingerprint encrypted with the fingerprint key kf 310). The second fingerprint encrypter/decrypter 334 may encrypt or decrypt the data fingerprint in the appropriate user key (e.g., the user associated with the data) as would be understood by one having ordinary skill in the art upon reading the present disclosure. For example, if the user owns user key k1 314, the second fingerprint encrypter/decrypter 334 decrypted the doubly encrypted fingerprint with user key k1 314 to retrieve the encrypted fingerprint. In various approaches, the location information (e.g., such as the logical block address for fixed block storage) for the data chunk, is sent in operation 412 to the second fingerprint encrypter/decrypter 334 where the location information is the IV used for the encryption/decryption.

The encrypted fingerprint (e.g., the singly encrypted fingerprint) output by the second fingerprint encrypter/decrypter 334 is sent in operation 414 to the data encrypter/decrypter 348 as the IV. The data encrypter/decrypter 348 uses the base key kb 308 as the decryption key and outputs the data chunk in operation 416.

In optional approaches, decompression techniques are used to decompress the data chunk using decompression unit 418 to provide the plaintext data chunk, in a manner which would be understood by one having ordinary skill in the art upon reading the present disclosure. The plaintext data chunk is sent in operation 420 to the dechunker 422.

End-to-end data integrity may be tested by sending the output data chunk in operation 424 to the fingerprint generator 326. The fingerprint generator 326 operates with the first fingerprint encrypter/decrypter 330 as described above with reference to FIG. 3 as for the write operation. The fingerprint generator 326 produces the encrypted fingerprint for the decrypted data chunk. This generated encrypted fingerprint is sent in operation 428 to a comparator 426. The other encrypted fingerprint (output by the second fingerprint encrypter/decrypter 334) is sent to the comparator 426 in operation 430. The comparator 426 compares the encrypted fingerprints in a manner known in the art. The two values for the encrypted fingerprints should be identical if there are no errors and/or no tampering, as would become apparent to one having ordinary skill in the art upon reading the present disclosure. The results of the comparison are sent in operation 432 to the dechunker 422. If the comparison is successful (e.g., the encrypted fingerprints match), the dechunker 422 may forward the read data 434 to the user in response to the read request, in a manner known in the art. If the comparison is unsuccessful, an error may be output in a manner known in the art, and the data is not forwarded. The system may take appropriate action including further determination techniques for identifying if the mismatch was the result of an error, tampering, an attack, etc. The system may attempt to recover the data through other means, such as via a replica, an erasure code, etc., if such recovery techniques are available.

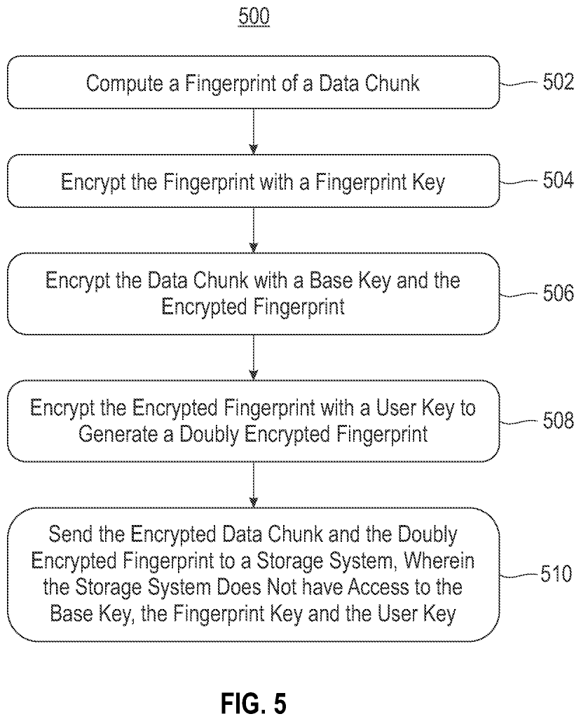

Now referring to FIG. 5, a flowchart of a method 500 is shown according to one aspect. The method 500 may be performed in accordance with the present invention in any of the environments depicted in FIGS. 1-4 and 6, among others, in various aspects. Of course, more or fewer operations than those specifically described in FIG. 5 may be included in method 500, as would be understood by one of skill in the art upon reading the present descriptions.

Each of the steps of the method 500 may be performed by any suitable component of the operating environment. For example, in various aspects, the method 500 may be partially or entirely performed by computers, or some other device having one or more processors therein. The processor, e.g., processing circuit(s), chip(s), and/or module(s) implemented in hardware and/or software, and preferably having at least one hardware component may be utilized in any device to perform one or more steps of the method 500. Illustrative processors include, but are not limited to, a central processing unit (CPU), an application specific integrated circuit (ASIC), a field programmable gate array (FPGA), etc., combinations thereof, or any other suitable computing device known in the art.

As shown in FIG. 5, method 500 includes operation 502. Operation 502 includes computing a fingerprint of a data chunk. In various aspects, in response to a write request, write data may be split into data chunks in any manner known in the art. The data chunks may be fixed lengths or may be variable lengths. A fingerprint is computed for each data chunk according to any cryptographic hash algorithm in the art including a MD5, SHA-1, SHA-256, etc. A fingerprint of the data chunk may be computed in any manner known in the art.

Operation 504 includes encrypting the fingerprint with a fingerprint key. In preferred aspects, the fingerprint key is part of a key group on a host system. The key group may include the fingerprint key, a base key, and at least one user key. In preferred aspects, the fingerprint key and the base key are shared between users of the key group for enabling deduplication of data written in any of the keys in the key group. The user keys are not shared between users of the key group. Deduplication is preferably permitted between data written by holders of users keys which belong to the key group as would become apparent to one having ordinary skill in the art upon reading the present disclosure. A fingerprint key encrypter may encrypt the fingerprint with the fingerprint key as would be understood by one having ordinary skill in the art upon reading the present disclosure.

In some approaches, operation 502 and operation 504 may be combined into substantially one process. For example, computing the fingerprint and encrypting the fingerprint may be part of an HMAC where the HMAC message is the data chunk plaintext and the encryption key is the fingerprint key.

Operation 506 includes encrypting the data chunk with a base key and the encrypted fingerprint. The base key may belong to the key group as described above. Encrypting the data chunk with the base key and the encrypted fingerprint preferably includes using the base key as the encryption key and using the encrypted fingerprint as a first initialization vector as would be understood by one having ordinary skill in the art upon reading the present disclosure.

In one approach, the data chunk may be compressed, prior to the encryption with the base key and the encrypted fingerprint, using any data compression technique known in the art. In some approaches, various compression techniques may be applied before and/or after chunking. In one configuration, pre-chunking compression may be a type of compression which improves the performance of the chunking. In another configuration, post-chunking compression may be tuned towards minimizing the resulting chunk size.

In preferred aspects, both the base key and the encrypted fingerprint are required to decrypt the data chunk (e.g., to recover the plaintext data chunk, in response to a read request). Identical data chunks produce identical encrypted data chunks (e.g., data chunks encrypted with the base key and the encrypted fingerprint). This property enables the storage system to identify data for the purposes of deduplication as would become apparent to one having ordinary skill in the art upon reading the present disclosure.

Operation 508 includes encrypting the encrypted fingerprint with a user key to generate a doubly encrypted fingerprint. In various aspects, the doubly encrypted fingerprint may be interchangeably referred to as a “locked fingerprint.” In preferred aspects, the user key is a member of the key group which enables deduplication for data which is written in a key belonging to the key group, as described above. The user key is preferably a key which is not shared with other users belonging to the key group (e.g., other users having user keys which are part of the key group). In various aspects, the doubly encrypted fingerprint refers to a fingerprint which is first encrypted with the fingerprint key (e.g., to generate the encrypted fingerprint as in operation 504) and then subsequently encrypted again (e.g., the encrypted fingerprint is encrypted) with the user key (e.g., to generate the doubly encrypted fingerprint).

In one optional approach, encrypting the encrypted fingerprint with the user key to generate the doubly encrypted fingerprint includes using a logical block address as a second initialization vector in a manner which would be understood by one having ordinary skill in the art upon reading the present disclosure. The logical block address is preferably the logical block address for the data chunk. In at least some approaches, the logical block address may include a set of logical block addresses which are associated with the data chunk. In various aspects, the logical block address may be used as an initialization vector for preventing a bad actor from reading the data by substituting fake data or moved data into the storage system. The logical block address as the initialization vector provides additional verification of the location of the data which is being written/read. For example, if the storage system attempts to return data from the wrong location in response to a read request, because the location (e.g., the logical block address) is part of the encryption, the substitution does not work.

Operation 510 includes sending the encrypted data chunk and the doubly encrypted fingerprint to a storage system. The storage system does not have access to any of the base key, the fingerprint key, and the user key. The encrypted data chunk and the doubly encrypted fingerprint may be sent to the storage system in a manner known in the art. The storage system is configured to identify data for the purposes of deduplication. For example, the storage system is able to identify encrypted data chunks which “match” for deduplication, in a manner known in the art, even though the storage system does not see the plaintext data (e.g., the data in the clear) or have access to any of the keys in the key group.

The storage system may store the encrypted data chunk and the associated doubly encrypted fingerprint in a manner so as to maintain this relationship. For example, encrypted fingerprints (e.g., doubly encrypted fingerprints) may be stored in the metadata storage that associates doubly encrypted fingerprints with data chunks. In one approach, the metadata storage for the doubly encrypted fingerprints is stored separately from the data storage for the encrypted data chunks (e.g., a separate storage device). In another approach, the metadata storage may be combined with data storage. There is little to no risk in combining storage for the encrypted data chunks and the doubly encrypted fingerprints where the storage system does not have access to any of the fingerprint key, the base key, and the user key. The storage system preferably does not have access to any of the shared keys. The storage system does not have access to any of the not-shared keys (e.g., the user keys).

In other approaches, the storage system comprises the encrypted data chunk and the doubly encrypted fingerprint where “doubly encrypted” refers to a fingerprint which is encrypted using the fingerprint key, and then encrypted by the AES-XTS type encryption described herein. In one approach, the storage system is a block store, and the metadata may include the logical block address of the data chunk as the association information, in a manner which would become apparent to one having ordinary skill in the art upon reading the present disclosure.

In an exemplary illustrative aspect, a first user may store data using a first user key k0 and a second user may store identical data using a second user key k1. User keys k0 and k1 are part of the same key group. Fingerprints and data chunks are encrypted and stored as described in detail above. In this illustrative aspect, the common encrypted data chunk is deduplicated in the storage system and the first user and the second user each store a doubly encrypted fingerprint at the storage system (where each doubly encrypted fingerprint is encrypted with the first user key k0 and the second key k1, respectively). The first user and the second user may each retrieve the common encrypted data chunk in response to a read request to the storage system and decrypt the encrypted data chunk and their doubly encrypted fingerprint using their associated user key. A third user using a third user key k2 will not be able to decrypt the encrypted data chunk (which is common between the first user and the second user) where the third user does not have access to the correct user key to decrypt either of the doubly encrypted fingerprints, even if the third user is part of the key group which shares the fingerprint key and the base key.

In various approaches, the storage system may receive a read request for data stored in the storage system. In response to the read request, the storage system may return the encrypted data chunk(s) and the doubly encrypted fingerprint(s) associated with the read request to the host system requesting the data. The host system decrypts the doubly encrypted fingerprint using the user key to produce the encrypted fingerprint (e.g., the singly encrypted fingerprint which is encrypted with the fingerprint key). The encrypted fingerprint is used by the host system as the IV with the base key as the decryption key to output the decrypted data chunk. The data chunk may be decompressed in optional aspects. In various approaches, a fingerprint may be computed on the output data chunk, in a manner as described above, and the computed fingerprint may be compared to the encrypted fingerprint (e.g., the singly encrypted fingerprint which is encrypted with the fingerprint key) to test end-to-end data integrity. The two encrypted fingerprints should be identical if there are no errors and no tampering. If the encrypted fingerprints match, the data may be returned as would become apparent to one having ordinary skill in the art upon reading the present disclosure. The host system may take appropriate action including further determination techniques for identifying if any mismatch was the result of an error, tampering, an attack, etc. The host system may attempt to recover the data through other means, such as via a replica, an erasure code, etc., if such recovery techniques are available.

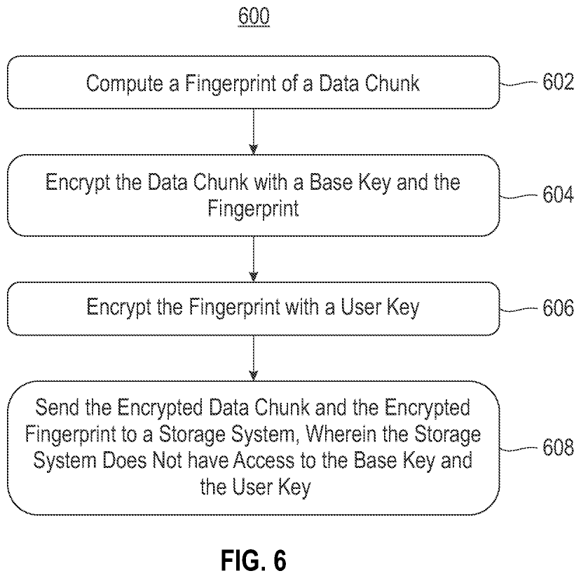

Now referring to FIG. 6, a flowchart of a method 600 is shown according to one aspect. The method 600 may be performed in accordance with the present invention in any of the environments depicted in FIGS. 1-5, among others, in various aspects. Of course, more or fewer operations than those specifically described in FIG. 6 may be included in method 600, as would be understood by one of skill in the art upon reading the present descriptions.

Each of the steps of the method 600 may be performed by any suitable component of the operating environment. For example, in various aspects, the method 600 may be partially or entirely performed by computers, or some other device having one or more processors therein. The processor, e.g., processing circuit(s), chip(s), and/or module(s) implemented in hardware and/or software, and preferably having at least one hardware component may be utilized in any device to perform one or more steps of the method 600. Illustrative processors include, but are not limited to, a central processing unit (CPU), an application specific integrated circuit (ASIC), a field programmable gate array (FPGA), etc., combinations thereof, or any other suitable computing device known in the art.

As shown in FIG. 6, method 600 includes operation 602. Operation 602 includes computing a fingerprint of a data chunk. In various aspects, in response to a write request, write data may be split into data chunks in any manner known in the art. The data chunks may be fixed lengths or may be variable lengths. A fingerprint is computed for each data chunk according to any cryptographic hash algorithm in the art including a MD5, SHA-1, SHA-256, etc. A fingerprint of the data chunk may be computed in any manner known in the art.

Operation 604 includes encrypting the data chunk with a base key and the fingerprint. In preferred aspects, the base key is part of a key group on a host system. The key group may include the base key and at least one user key. In preferred aspects, the base key is shared between users of the key group for enabling deduplication of data written in a key belonging to the key group. Encrypting the data chunk with the base key and the fingerprint preferably includes using the base key as the encryption key and using the fingerprint as a first initialization vector as would be understood by one having ordinary skill in the art upon reading the present disclosure.

In various aspects, encrypting the data with the base key and the fingerprint as the IV uses XTS mode AES encryption. Encrypting the data with the base key and the fingerprint as the IV using XTS mode implicitly encrypts the IV as part of encrypting the data chunk. The fingerprint (e.g., the unencrypted fingerprint used as the input IV to encrypt the data chunk) remains unencrypted, as would become apparent to one having ordinary skill in the art upon reading the present disclosure.

Operation 606 includes encrypting the fingerprint with a user key. In preferred aspects, the user key is a member of the key group which enables deduplication for data which is written in a key belonging to the key group, as described above. The user key is preferably a key which is not shared with other users belonging to the key group (e.g., other users having user keys which are part of the key group). Encrypting the fingerprint with the user key as in operation 606 preferably generates an encrypted fingerprint where the fingerprint is encrypted in the user key (e.g., singly encrypted). In these approaches, encrypting the fingerprint with the user key to generate the singly encrypted fingerprint may include using a logical block address associated with the data chunk as a second initialization vector for the encryption of the fingerprint using the user key, in a manner which would become apparent to one having ordinary skill in the art upon reading the present disclosure.

Operation 608 includes sending the encrypted data chunk and the encrypted fingerprint to a storage system. The storage system does not have access to any of the base key and the user key. The encrypted data chunk and the encrypted fingerprint may be sent to the storage system in a manner known in the art. The storage system is configured to identify data for the purposes of deduplication. For example, the storage system is able to identify encrypted data chunks which “match” for deduplication, in a manner known in the art, even though the storage system does not see the plaintext data (e.g., the data in the clear) or have access to any of the keys in the key group.

The storage system may store the encrypted data chunk and the associated encrypted fingerprint in a manner so as to maintain this relationship. For example, encrypted fingerprints may be stored in the metadata storage that associates encrypted fingerprints with data chunks. In one approach, the metadata storage for the encrypted fingerprints is stored separately from the data storage for the encrypted data chunks (e.g., a separate storage device). In another approach, the metadata storage may be combined with data storage. There is little to no risk in combining storage for the encrypted data chunks and the encrypted fingerprints where the storage system does not have access to any of the base key and the user key. The storage system preferably does not have access to any of the shared keys. The storage system does not have access to any of the not-shared keys (e.g., the user keys).

A benefit of the encryption methods described herein using locked fingerprints includes the ability to securely deduplicate encrypted data with enhanced protection from attacks. For example, if a bad actor attempted to access data in the storage system, even if they had access to one of the shared keys (e.g., the base key or the fingerprint key), which is used to encrypt the data or the fingerprint, the bad actor would not be able to access the data in the clear without the having access to the initialization vector (e.g., the encrypted fingerprint, the HMAC, the logical block address, etc.) which was used in the encryption. Furthermore, if a bad actor had access to the not-shared user key, they would still need to know the logical block address to decrypt the metadata (e.g., the doubly encrypted fingerprint) in order to access the plaintext data. At least some of the aspects described herein provide several levels of protection and data privacy while enabling deduplication of data encrypted in different user keys.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Moreover, a system according to various embodiments may include a processor and logic integrated with and/or executable by the processor, the logic being configured to perform one or more of the process steps recited herein. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer program product, the computer program product comprising:
one or more computer readable storage media, and program instructions collectively stored on the one or more computer readable storage media, the program instructions comprising:
program instructions to compute a fingerprint of a data chunk,
program instructions to encrypt the fingerprint with a fingerprint key,
program instructions to encrypt the data chunk with a base key and the encrypted fingerprint,
program instructions to encrypt the encrypted fingerprint with a user key to generate a doubly encrypted fingerprint; and
program instructions to send the encrypted data chunk and the doubly encrypted fingerprint to a storage system, wherein the storage system does not have access to the base key, the fingerprint key and the user key.

2. The computer program product of claim 1, wherein computing the fingerprint and encrypting the fingerprint is performed using a keyed-hash message authentication code.

3. The computer program product of claim 1, wherein encrypting the data chunk with the base key and the encrypted fingerprint includes encrypting the data chunk using the encrypted fingerprint as a first initialization vector.

4. The computer program product of claim 1, wherein encrypting the encrypted fingerprint with the user key to generate the doubly encrypted fingerprint includes using a logical block address as a second initialization vector.

5. The computer program product of claim 1, wherein the storage system is configured to perform deduplication operations on the encrypted data chunk.

6. A computer program product, the computer program product comprising:
one or more computer readable storage media, and program instructions collectively stored on the one or more computer readable storage media, the program instructions comprising, comprising:
program instructions to compute a fingerprint of a data chunk,
program instructions to encrypt the fingerprint with a fingerprint key,
program instructions to encrypt the data chunk with a base key and the encrypted fingerprint,
program instructions to encrypt the encrypted fingerprint with a user key to generate a doubly encrypted fingerprint; and
program instructions to send the encrypted data chunk and the doubly encrypted fingerprint to a storage system, wherein the storage system does not have access to the base key, the fingerprint key and the user key.

7. The computer program product of claim 6, wherein computing the fingerprint and encrypting the fingerprint is performed using a keyed-hash message authentication code.

8. The computer program product of claim 6, wherein encrypting the data chunk with the base key and the encrypted fingerprint includes encrypting the data chunk using the encrypted fingerprint as a first initialization vector.

9. The computer program product of claim 6, wherein encrypting the encrypted fingerprint with the user key to generate the doubly encrypted fingerprint includes using a logical block address as a second initialization vector.

10. The computer program product of claim 6, wherein the storage system is configured to perform deduplication operations on the encrypted data chunk.

11. A computer-implemented method, comprising:
computing a fingerprint of a data chunk,
encrypting the fingerprint with a fingerprint key,
encrypting the data chunk with a base key and the encrypted fingerprint,
encrypting the encrypted fingerprint with a user key to generate a doubly encrypted fingerprint; and
sending the encrypted data chunk and the doubly encrypted fingerprint to a storage system, wherein the storage system does not have access to the base key, the fingerprint key and the user key.

12. The method of claim 11, wherein computing the fingerprint and encrypting the fingerprint is performed using a keyed-hash message authentication code.

13. The method of claim 11, wherein encrypting the data chunk with the base key and the encrypted fingerprint includes encrypting the data chunk using the encrypted fingerprint as a first initialization vector.

14. The method of claim 11, wherein encrypting the encrypted fingerprint with the user key to generate the doubly encrypted fingerprint includes using a logical block address as a second initialization vector.

15. The method of claim 11, wherein the storage system is configured to perform deduplication operations on the encrypted data chunk.

16. A computer-implemented method, comprising:
computing a fingerprint of a data chunk,
encrypting the data chunk with a base key and the fingerprint,
encrypting the fingerprint with a user key; and
sending the encrypted data chunk and the encrypted fingerprint to a storage system, wherein the storage system does not have access to the base key and the user key.

17. The method of claim 16, wherein encrypting the data chunk with the base key and the fingerprint includes encrypting the data chunk using the fingerprint as a first initialization vector.

18. The method of claim 16, wherein encrypting the fingerprint with the user key to generate an encrypted fingerprint includes using a logical block address as a second initialization vector.

19. The method of claim 16, wherein the storage system is configured to perform deduplication operations on the encrypted data chunk.

20. The method of claim 16, wherein encrypting the data chunk with the base key and the fingerprint uses XTS mode AES encryption.

21. A system, comprising:
a processor; and
logic integrated with the processor, executable by the processor, or integrated with and executable by the processor, the logic being configured to:
compute a fingerprint of a data chunk,
encrypt the fingerprint with a fingerprint key,
encrypt the data chunk with a base key and the encrypted fingerprint,
encrypt the encrypted fingerprint with a user key to generate a doubly encrypted fingerprint; and
send the encrypted data chunk and the doubly encrypted fingerprint to a storage system, wherein the storage system does not have access to the base key, the fingerprint key and the user key.

22. The system of claim 21, wherein computing the fingerprint and encrypting the fingerprint is performed using a keyed-hash message authentication code.

23. The system of claim 21, wherein encrypting the data chunk with the base key and the encrypted fingerprint includes encrypting the data chunk using the encrypted fingerprint as a first initialization vector.

24. The system of claim 21, wherein encrypting the encrypted fingerprint with the user key to generate the doubly encrypted fingerprint includes using a logical block address as a second initialization vector.

25. The system of claim 21, wherein the storage system is configured to perform deduplication operations on the encrypted data chunk.
